(19) United States
(12) Patent Application Publication
(10) Pub. No.: US 2023/0390710 A1
(43) Pub. Date: Dec. 7, 2023

(54) MEMBRANES MADE USING FINE POWDERS

(71) Applicant: Arkema Inc., King of Prussia, PA (US)

(72) Inventors: Gregory S. O'BRIEN, King of Prussia, PA (US); Walter P. KOSAR, King of Prussia, PA (US); Saeid ZERAFATI, King of Prussia, PA (US)

(21) Appl. No.: 18/034,462

(22) PCT Filed: Oct. 29, 2021
(86) PCT No.: PCT/US2021/057165

§ 371 Date: Apr. 28, 2023

Related U.S. Application Data
(60) Provisional application No. 63/107,467, filed on Oct. 30, 2020.

(51) Int. Cl. B01D 71/34; B01D 67/00; B01D 69/02

(52) U.S. Cl. CPC B01D 71/34; B01D 67/00111; B01D 67/0018; B01D 67/003; B01D 69/02; B01D 2323/21; B01D 2325/24; B01D 2325/20; B01D 2323/12; B01D 2323/219

(57) ABSTRACT

This invention allows for the production of high strength and high permeability TIPS membranes using extractable fillers with fine powder PVDF grades.

### FIELD OF THE INVENTION

This invention allows for the production of high strength and high permeability TIPS (Thermally Induced Phase Separation) membranes using extractable fillers with fine powder emulsion PVDF grades (D50 of from 3 to 15 micron).

### BACKGROUND OF THE INVENTION

PVDF membranes are most commonly produced by a Non-solvent Induced Phase Separation (NIPS) process where PVDF is dissolved in a strong solvent with pore formers, and then processed by spinning a shape such as a hollow fiber into a non-solvent (such as water). In this process, the solvent, which is water soluble, diffuses out of the shaped membrane and the non-solvent/water diffuses into the membrane to produce a microporous membrane structure. The non-solvent in the coagulation bath diffuses into the polymeric solution and the solvent diffuses into the non-solvent bath in de-mixing process, which essentially is an exchange between the solvents. The polymer comes out of solution as a result of contact with the nonsolvent and solidifies. The largest volume application for PVDF membranes are hollow fiber membranes for durable water filtration.

An alternate process for producing microporous PVDF hollow fiber membranes is called Thermally Induced Phase Separation (TIPS). In this case, the phase separation process is driven by cooling which causes phase separation between PVDF and a non-water soluble latent solvent. Typically—this TIPS process uses both a latent solvent and an extractable filler—where the filler is removed by chemical extraction to increase porosity and permeability. In a TIPS process, the polymer composition is melt extruded at elevated temperatures (as for example 140 to 270 C.) and then cooled to solidify the shaped membrane film. The cooled and solidified hollow fiber film is then introduced into an extraction liquid bath to remove the plasticizer and the solvent, thereby forming a hollow fiber membrane. The extraction liquid is not particularly restricted provided that it does not dissolve the vinylidene fluoride resin while dissolving the plasticizer and the latent solvent. Flat sheet membranes can also be made using the TIPS process.

In hollow fiber membranes, strength is most importantly driven by the weight percent solids of PVDF in the formulation that is used to spin the hollow fibers. Namely, as the weight percent PVDF is increased, the strength increases and the permeability decreases. Without the use of filler in the TIPS formulation—there is a trade off between strength and permeability. Therefore, it is difficult to achieve a TIPS membrane, with high strength, high permeation and having good elongation to break without the use of an extractable filler in addition to the solvent

U.S. Pat. No. 5,022,990 discloses a method of pre-blending of all ingredients together in a Henschel high intensity mixer that is not workable for emulsion grade PVDF. Typical formulations (in U.S. Pat. No. 5,022,990) contain 40% by weight PVDF, 30.7% by weight di-octyl phthalate (DOP), 6.2% by weight di-butyl phthalate (DBP), and 23.1% by weight hydrophobic fumed silica (Aerosil® R972). While this works with the large particles size of suspension grade PVDF, when tried with emulsion fine powder (PSD of 3-15 microns) an intractable paste forms during the blending operation. PSD means particle size distribution and provides the average particle size). The examples in U.S. Pat. No. 5,022,990 all use suspension grade PVDF with a PSD of 150 -250 microns and fillers.

U.S. Pat. No. 5,022,990 discloses a typical formulation of ingredients and process that allow for a good combination of both permeability and strength. The invention of Asahi Kasei was that by using an extractable filler—high solids can be used to achieve higher tensile strength, because the filler can be extracted to increase permeability. In the examples shown, the final porosity is noted at 64-66%. However, in the examples listed—the extractable filler is about 15% by volume. All of the examples in this patent utilize suspension grade PVDF. The average particle size for this powder is between 200 to 215 microns depending on the method used for measurement. The blend of filler, PVDF powder and organic liquid (a blend of DBP and DOP) are prepared in a high speed Henschel blender. This blend has enough fluidity and powder flow to be feed to a twin screw extruder. If a similar blend is attempted with an emulsion fine powder grade of PVDF, a thick intractable paste is created. Therefore, making a TIPS membrane by this process is impossible with a fine powder emulsion grade PVDF, as the paste produced cannot be fed to an extruder.

WO2006006340 discloses a similar blending process as U.S. Pat. No. 5,022,990—pre-mixing all the ingredients in a Henschel mixer, followed by extrusion and extraction but specifies the PSD of the PVDF to be 20-250 microns. This PSD range is outside the range achieved with emulsion grade PVDF of 3-15 micron. The examples all use suspension grade PVDF and Aerosil.

US20180056247 discloses producing PVDF slurries of specific particle size PVDF powders in TIPS latent solvents. This patent attempted to solve the problem for emulsion grade PVDF by changing the form of that powder to allow for a 40% solids slurry with solvent to be made that could then be fed to the back of a twin-screw extruder as a pumpable liquid. The PVDF used for this mixture has an average particle size ranging from 20-200 micron of an emulsion PVDF that was transformed to a larger particle size PVDF. This offered the potential to produce a free-flowing and stable slurry of PVDF and solvent, that could be pumped as a liquid to a twin-screw extruder and the spun into a hollow fiber. It however requires a very specific PSD to allow for a stable slurry of latent solvent and PVDF that is pumpable in a liquid form to a twin screw. This particle size is larger than what is produced in the typical PVDF emulsion powder (3-15 micron D50). One counter example showed that an intractable paste was developed when a similar blend was made with a 10 micron PSD PVDF (which is within the “normal” range of PSD for emulsion grade PVDF)

JP2010-227932 discloses a TIPS process for making hollow fiber membranes.

JP 2012-236178 discloses a similar mix all ingredients in a Henschel mixer. The experiments all use suspension grade PVDF and Aerosil R972.

US2012/0012521 Discloses feeding PVDF separately from a blend of good solvent (NMP) and latent solvent (polyester plasticizer) into a twin screw. It does not utilize any “extractable” filler, and the resultant membranes have very low elongation to break.

WO2010020115 Discloses mixing PVDF and solvent at high temperature in a hot stirred tank which is then fed in a molten state to an extruder for membrane spinning.

U.S. Pat. No. 8,967,391 Discloses blending PVDF, organic solvents (pore formers), and inorganic pore formers with a composition of: 25% NanoZnO (30-50 nm), 40% PVDF 500 k MW, 33.8% DOP, 1.2% DBP. All the ingredients were mixed together in a Henschel mixer and fed to the back of a twin-screw extruder. Once again—all examples are with suspension grade PVDF powder with a PSD of 200-250 microns.

Prior art teaches blending all the ingredients in a Henschel and then feeding that to an extruder. This is not practical for fine particle size distribution PVDF (PSD=3-15 micron D50), as the mixture will become an intractable paste, especially when one utilizes extractable fillers. No one has solved this problem to date.

Others have fed the latent solvent down-stream when no fillers are being employed. However, the best combination of mechanical properties and permeability is achieved when extractable fillers are added, and there is a desire to have the “best” distribution of that extractable filler in the final membrane to give uniform porosity. A ratio of PVDF powder to extractable filler of 2:1 by weight makes an extremely high viscosity material in the extruder without the addition of a portion of the solvent. In addition—adding the extractable filler downstream would be difficult (due to low bulk density) and would be difficult to disperse uniformly.

No one has discovered an effective method for producing a TIPS membranes using emulsion grade PVDF with both high permeability greater than 800 lmhb and preferably greater than 1000 lmhb and high tensile strength greater than 8 and preferably greater than 10 Mpa. No one has defined a way to effectively compound a fine powder produced by emulsion PVDF with both filler and solvent.

This invention overcomes issues related to using fine powder PVDF such as emulsion PVDF to make Thermally Induced Phase Separation (TIPS) membranes. Typically, suspension grade PVDF is used for making TIPS membranes. In that process, the suspension powder (typically 140 to 250 micron D50 PSD) is premixed with fillers and latent solvents and fed to the rear feedport of a twin-screw extruder to melt and produce a uniform composition. An example composition as disclosed in JP2010-227932 (example 1) includes 40% by weight PVDF, 37% by weight latent solvents, and 23% of fine powder silica or ZnO. If this same mixture is attempted with fine powder PVDF with a typical D50 PSD as measured by Microtrac laser diffraction equipment of 3-15 micron the mixture turns into a solid paste, which cannot be fed to an extruder.

It has been surprisingly found that a typical TIPS formulation with PVDF, latent solvents and filler can be successfully compounded/produced by a new and inventive method of blending preferably using a twin-screw extruder or co kneader. This invention discovered that a blend of fine powder PVDF with the fine particle size filler remain a free-flowing powder even with the addition of a significant loading of latent solvent (15-30% by weight of composition). This then allows a uniform composition to be produced utilizing twin-screw or Buss co-kneader compounding with the addition of the balance of the latent solvent needed added downstream after melting of the PVDF to produce a final composition having from 35 to 55wt % latent solvent. The initial blending of fine-powders in the dry state—helps to produce a more uniform final composition. This free-flowing powder blend is then fed to the rear feed section of a twin-screw (or co-kneader), and additional latent solvent is fed down-stream preferably using a liquid injection system. It has not been possible to produce these blends in a twin-screw/co-kneader previously with emulsion grade PVDF powder. When membranes are cast from this composition, they are both strong and high permeability. Preferably, the membrane has a Permeability of greater than or equal to 800 lmbh, a Strength of greater than or equal to 8 MPa (as measure by the test methods described here in). The membrane may have a ductility, measured by elongation to break, of greater than 100.

The uniqueness of this invention is the ability to effectively pre-disperse the fine powder extractable filler with a fine powder PVDF grade (PSD D50 of 3 to 15 micron) and adding a portion of latent solvent while keeping the powder free flowing. The particle size of the filler powder added is less than 1 micron and can be difficult to disperse uniformly. By high intensity pre-blending (for example in a Henshel blender at more than 500 rpm) with emulsion grade PVDF powder with a typical D50 PSD of 3 to 15 micron, the filler is effectively “pre-dispersed” which makes a uniform dispersion in the final membrane more effective. This can be important since the filler is later extracted to create additional pores in the final membrane. Agglomerates of these fillers could lead to non-uniform porosity or even macrovoids.

### SUMMARY OF THE INVENTION

The invention provides for a composition for TIPS membranes comprising 30 to 50% by weight PVDF powder having a D50 of from 3 to 15 micron, 15 to 25% by weight fine powder extractable filler having a particle size of 1 to 250 nm, 35 to 55% organic latent solvent and from 0 to 10% by weight additives.

The invention also relates to a process for producing a compound for TIPS membranes where the free-flowing blend noted above is fed in the rear of a twin-screw or co-kneader, and the balance of the solvent is added downstream by a means such as liquid injection, post melting of the PVDF.

The invention also relates to a process to make a porous membrane from the inventive composition/process. A method of preparing fine powder PVDF for TIPS membrane formation is disclosed. The method comprises (1) forming a free flowing powder pre-blend by blending fine powder PVDF with fine powder extractable filler and latent solvent to produce a free flowing powder blend having 15-30% by weight latent solvent based on the weight of the free flowing powder blend, (2) feeding the free flowing powder blend to an extruder to melt the free flowing powder blend and adding additional latent solvent after melting by down-stream addition by a means such as liquid injection, (3) extruding the melted powder blend preferably in pellet form, (4) feeding the extruded melted powder blend of (3) to an extruder where the molten product is shaped into a membrane, and extruded into a water bath, (5) extracting the solvent from the membrane with alcohol, (6) extracting the filler with acid or base, (7) washing the membrane with water. Steps 3 and 4 can be combined into one step using a single extruder to both blend the pre-blend with the additional latent solvent and then extrude the membrane.

The invention further relates to porous membranes formed from the composition of the invention.

### ASPECTS OF THE INVENTION

Aspect 1: A composition for TIPS membranes comprising
a. 30 to 50% PVDF,
b. 15 to 25% fine powder extractable filler having an average particle sizes of between 1 to 250 nm,
c. 35 to 55% organic latent solvent, and
d. 0 to 10% additives,
   wherein the PVDF has a heat of melting Delta H of from 45 to 55 J/gm on the second heat D3418 (DSC), and the percent of reverse units by NMR is from 4.6 to 5.8.

Aspect 2: The composition of aspect 1 wherein the PVDF powder has a melting point of between 160 to 170 C on second heat.

Aspect 3: The composition of aspect 1 or 2 wherein the PVDF powder comprises from 30 to 45 wt percent of the composition and the organic latent solvent comprises from 35 to 42 wt percent of the composition.

Aspect 4: The composition of any one of aspects 1 to 3 wherein the PVDF is a homopolymer or copolymer comprising at least 95 weight % vinylidene fluoride.

Aspect 5: The composition of any one of aspects 1 to 4 wherein the fine powder extractable filler is selected from the group consisting of including fumed silica, zinc oxide, aluminum oxide, zirconium oxide, iron oxide, calcium carbonate, and combination thereof.

Aspect 6: The composition of any one of aspects 1 to 5 wherein the latent solvent is selected from the group consisting of Diethylphthalate, dibutylphthalate, dibutylsebacate, acetyl-tributylcitrate, tributylcitrate, acetyl-triethylcitrate and combinations thereof.

Aspect 7: A method for producing a porous membrane comprising the steps of
(i) feeding the composition of any one of aspects 1 to 6, preferably in pellet form, to an extruder,
(ii) extruding the melted product to form a structure
(iii) Extracting the solvent from the structure with an organic solvent preferably alcohol,
(iv) Extracting the filler with acid or base,
(v) washing the structure with pure water to produce a porous membrane.

Aspect 8: A method for producing a porous membrane comprising the steps of
(a) Pre-blending fine powder PVDF having a D50 of 3 to 15 micron, fine powder extractable filler having average particle sizes of between 1 to 250 nm and latent solvent to produce a free flowing powder blend, wherein the free flowing powder blend contains 15-30% by weight of a latent solvent,
(b) feeding the free flowing powder blend to an extruder or kneader wherein the free flowing powder blend is melted to produce a melted blend,
(c) feeding an additional aliquot of latent solvent down-stream in the extruder or kneader into the melted blend to produce a melted product,
(d) extruding the melted product to form a structure,
(e) extracting the solvent from the structure with organic solvent, preferably alcohol, and
(f) extracting the filler with acid or base; to produce a porous membrane.

Aspect 9: The method of aspect 8, wherein the PVDF has a heat of melting Delta H of from 45 to J/gm on the second heat ASTM D3418 (DSC), and the percent of reverse units by NMR is from 4.6 to 5.8.

Aspect 10: The method of aspect 8 or 9, further comprising step (g) of washing the structure with water after step (f).

Aspect 11: The method of any one of aspects 8 to 10, wherein the amount of the additional aliquot of latent solvent is from 5 to 50 wt % , preferably from 7 to 47% by weight based on the total weight of the material prepared in (a).

Aspect 12: The method of any one of aspects 8 to 11, wherein in step (a) the fine powder PVDF and the fine powder extractable filler are first blended followed by the addition of the latent solvent.

Aspect 13: The method of any one of aspects 8 to 12, further comprising the steps of
(c2) extrude out solid pellets from step (c), and
(c3) Feeding the pellets to a second extruder.

Aspect 14: The method of any one of aspects 8 to 13, wherein the structure exiting step (d) extrudes into a water bath.

Aspect 15: The method of any one of aspects 7 to 14, wherein the PVDF is a homopolymer or copolymer comprising at least 95 weight % vinylidene fluoride.

Aspect 16: The method of any one of aspects 7 to 15, wherein the fine powder extractable filler is selected from the group consisting of including fumed silica, zinc oxide, aluminum oxide, zirconium oxide, iron oxide, and calcium carbonate and combination thereof.

Aspect 17: The method of any one of aspects 7 to 15, wherein the fine powder extractable filler comprises fumed silica.

Aspect 18: The method of any one of aspects 7 to 15, wherein the fine powder extractable filler comprises zinc oxide.

Aspect 19: The method of any one of aspects 7 to 18, wherein the latent solvent is selected from the group consisting of dirnethyl phthalate, diethyphthaate, dibutylphthalate, dioctylphthaLate, diethylhexylphthalate, dibutylsebacate, triethylcitrate, acetyl-triethylcitrate, tributylcitrate, acetyle-tributylcitrate, glycerol triacetate (Triacetin), glycerol tributyrate (Tributyrin), propylene carbonate, diphenylcarbonate, butyllevulinate, n-octylpyrrolidone, benzoic acid esters such as methyl benzoate and ethyl benzoate, phosphoric acid esters such as triphenyl phosphate, tributyl-phosphate, tricresyl phosphate , dimethyl succinate, diethyl succinate, gamma valerolactone, and mixtures thereof.

Aspect 20: The method of any one of aspects 7 to 18, wherein the latent solvent is selected from the group consisting of Diethylphthalate, dibutylphthalate, dibutylsebacate, acetyl-tributylcitrate, tributylcitrate, acetyl-triethylcitrate, triethylcitrate, and combinations thereof.

Aspect 21: A membrane made by the method of any one of aspects 7 to 20 wherein the membrane has a flowrate of at least 800 lmhb and a tensile strength of at least 8 MPa, preferably at least 1000 lmbh and at least 10 MPa.

### BRIEF DESCRIPTION OF THE FIGURES

FIG. 1 Schematic of on embodiment of the inventive process.

FIG. 2 Graph showing the relationship of solids content on water permeability and on mechanical strength.

### DETAILED DESCRIPTION OF THE INVENTION

PVDF Particle size is measured by Microtrac Laser Particle size analyzer (using Laser diffraction).

Free flowing means the ability to be fed uniformly (at consistent kg/hour rate) through a powder feeder (such as K-Tron K-CL-FSF KT20 or KT35 on D5 platform gravimetric feeders) without bridging.

As used herein, unless otherwise indicated, percentages are weight percent, melt viscosity is measured using ASTM 3825 at 100 sec-1 and 232C and all references cited are incorporated herein by reference.

PVDF means a Polyvinylidene fluoride polymer (homopolymer or copolymer). Fine Powder PVDF means a Polyvinylidene fluoride polymer produced by emulsion polymerization and having a D50 powder size of 3-15 micron.

Fine powder extractable filler means a filler with an average particle size of 1 to 250 nm that is capable of being removed from the formed article (such as a membrane) generally using a solvent, heat, or chemical degradation using acid or base. Preferably the filler has a surface area of greater than 20 m2/g. It is understood that the particle size of the fine powder extractable filler refers to the size of the primary particle.

This invention relates to a composition having a fine particle size range of PVDF resin, a method of making the composition, and a method of making a membrane from the composition via a TIPS process.

This invention allows to the production of uniform porosity membranes using extractable fillers and fine particle PVDF. This invention solves the problem by pre-blending fine powders PVDF, fine powder extractable filler, and latent solvent while maintaining a free flowing powder blend where the pre-blend comprises from 15-30% by weight of the latent solvent. Never has this solution been identified prior to our invention. In addition adding a significant portion of solvent to the powder—maintains a reasonable viscosity for compounding without excessive shear heating.

We have discovered a unique process to produce a compound to allow the production of uniform pore size distribution TIPS membrane while overcoming the handling issues noted in previous patents such as an intractable paste formation. This invention utilizes a pre-blend of emulsion grade PVDF powder with extractable filler, and a portion of the latent solvent.

The compositions covered by this invention comprises:
a) Fine Powder PVDF (3-15 micron D50 by laser diffraction): 30% to 50% by weight
b) Fine powder extractable filler with an average particle size of 1 to 250 nm: 15-25% by weight
c) Organic Latent Solvent or Solvent blend—35 -55% by weight
d) optionally additives—0 to 10%

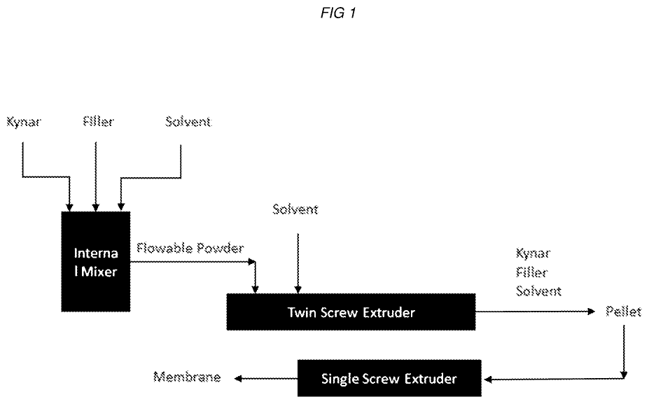

Preferably, the PVDF/filler powder blend is agitated to produce a uniform blend, and then the latent solvent fluid is gradually added while blending to disperse it effectively to achieve a pre-blend containing 15 to 30 wt percent latent solvent. Alternatively, any order of addition is acceptable as long as the composition is maintained as a free flowing powder. Depending on the type and size of the extractable filler, the fluid addition level (wt %) is controlled to keep good powder flow without caking in a typical Loss-in-weight (LIW) powder feeder system. This flowable pre-blend is fed into an extruder such as a twin-screw or co-kneader extruder to produce a melt. The remainder of the latent solvent (additional aliquot needed for the final formulation) is added down-stream via a loss-in-weight (LIW) liquid feeder (such as K-Tron K-ML-D5-P gravimetric liquid feeder) after the pre-blend is in a melted state. In this way, a uniformly dispersed filler in a melted product can be achieved without excessive heat generation (due to the presence of the latent solvent in the feed powder pre-blend-(initial addition), and the remainder of the latent solvent (additional aliquot) added down-stream in the extruder/kneader. Without the addition of the latent solvent to the powder pre blend excessive shear heating can take place. With this invention due to the powder pre blend step—a uniform distribution of the filler is achieved. The downstream addition of the additional aliquot of latent solvent should occur at a temperature that allows easy incorporation of that latent solvent (preferably between 130 C-230 C) with a LIW feeder system to closely control the final formulation of the compound to be extruded subsequently into a hollow fiber or flat sheet membrane. FIG. 1 shows a schematic embodiment of the inventive process.

The resultant formulation can be pelletized by strand or underwater cutting and can then in a second step be extruded using a single screw extruder, equipped with a gear pump and capillary die into a hollow fiber membrane, In this case the extruder should be run at proper temperature profile and processing conditions to prevent premature phase separation and leach out of the solvent.

Alternatively, the twin-screw could be equipped with a gear pump and a membrane die to produce the membrane directly.

### Polymer

The polymer of the invention can be any fluoropolymers polymer used for forming membranes by the TIPS process. Especially useful fluoropolymers include, but are not limited to the homo—and copolymers having a majority of monomer units being either vinylidene fluoride or vinyl fluoride, ethylene tetrafluoroethylene (ETFE), and ethylenechloro trifluoroethylene (ECTFE). Polyvinylidene fluoride containing copolymers are the most preferred. The invention will use polyvinylidene fluoride as an exemplary fluoropolymer, but one of skilled in the art can easily envision using polyvinyl fluoride, ETFE, ECTFE and other similar polymers with the same parameters described.

The polyvinylidene fluoride resin (PVDF) composition of the invention is preferably a homopolymer made by polymerizing vinylidene fluoride (VDF), copolymers, terpolymers and higher polymers of vinylidene fluoride wherein the vinylidene fluoride units comprise is typically greater than percent of the total weight of all the monomer units in the polymer, and more preferably, comprise greater than 75 percent of the total weight of the units. It is possible however especially when copolymers are made with tetrafluoroethylene (TFE) that the VDF could be as low as 25 weight percent of the total monomers. Copolymers, terpolymers and higher polymers of vinylidene fluoride may be made by reacting vinylidene fluoride with one or more monomers from the group consisting of vinyl fluoride , trifluoroethene, tetrafluoroethene, one or more of partly or fully fluorinated alpha-olefins such as 3,3,3-trifluoro-1-propene, 1,2,3,3,3 pentafluoropropene, 3,3,3,4,4-pentafluoro-1-butene, hexafluoropropene, trifluoromethyl-methacrylic acid, trifluoromethyl methacrylate, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro (1,3 dioxole) and perfluoro (2,2-dimethyl-1,3 - dioxole), allylic, partly fluorinated allylic, or fluorinated allylic monomers, such as 2-hydroxyethyl allyl ether or 3-allyloxypropanediol, ethene, propene. Preferred copolymers or terpolymers are formed with vinyl fluoride, trifluoroethene, tetrafluoroethene (TFE), and hexafluoropropene (HFP). Most preferred copolymers are formed with hexafluoropropene (HFP). One preferred PVDF is Kynar™PVDF by Arkema.

While an all fluoromonomer containing copolymer is preferred, non-fluorinated monomers such as vinyl acetate, methacrylic acid, and acrylic acid, may also be used to form copolymers, at levels of up to 5 weight percent based on the polymer solids.

Preferred copolymers are of VDF comprising from about 71 to about 99 weight percent VDF, and correspondingly from about 1 to about 29 percent TFE; from about 71 to 99 weight percent VDF, and correspondingly from about 1 to 29 percent HFP (such as disclosed in U.S. Pat. No. 3,178,399); and from about 71 to 99 weight percent VDF, and correspondingly from about 1 to 29 vsieight percent trifluoroethylene.

Another preferred embodiment provides for copolymers of VDF and TFE are envisioned where the TFE is in the range of 25 to 75 weight percent with the remainder being VDF.

Another Preferred embodiment provides for terpolyrners such the terpolymer of VDF, HFP and TFE, and the terpolyrner of VDF, trifluoroethene and TFE. The contemplated terpolyrners could have from 24 to 75 weight percent VDF, the HFP or trifluoroethene content could range from 1-40 weight percent and the TFE content could range from 24 to 75 weight percent. A preferred terpolymer is 45-55% IFE, 25-35% VDF and 10-20% HFP.

Mixtures of polyvirtyliderie fluoride polymer is also envisioned as part of the invention, including functionalized polymers with non-functionalized polymers, and polymers having different melt viscosities.

The fine powder PVDF preferably has a D50 particles size range of 3 to 15 micron as measure by Microtrac laser diffraction.

The PVDF has a heat of melting of Delta H of 45 to 55 J/gm on the second heat according to ASTM D3418 (DSC), and the percent of reverse units by NMR is between 4.6 to 5.8.

Preferably, the PVDF powder has a melting point of between 160 to 170 C on second heat (ASTM D3418).

### Latent Solvent

The polymer particles are blended with latent solvents, to form the free-flowing, powders. Latent solvents are organic liquids which do not dissolve (less than 5% by weight soluble) or substantially swell the fluoropolymer resin at room temperature, but will dissolve the fluoropolymer resin at elevated temperatures.

Solvents that will dissolve the polymer are not preferred, and this will lead to a viscosity increase. Useful latent solvents for the invention include, but are not limited to, dimethyl phthalate, diethylphthalate, dibutylphthalate, dioctylphthalate, diethylhexylphthalate, dibutylsebacate, triethylcitrate, acetyl-triethylcitrate, tributylcitrate, acetyl-tributylcitrate, glycerol triacetate (Triacetin), glycerol tributyrate (Tributyrin), propylene carbonate, diphenylcarbonate, butyllevulinate, n-octylpyrrolidone, benzoic acid esters such as methyl benzoate and ethyl benzoate, phosphoric acid esters such as triphenyl phosphate, tributyl-phosphate, and tricresyl phosphate; dimethyl succinate, diethyl succinate, gamma valerolactone, and mixtures thereof.

Preferred latent solvents are Diethylphthalate, dibutylphthalate, dibutylsebacate, acetyl-tributylcitrate, tributylcitrate, acetyl-triethylcitrate, triethylcitrate, and mixtures thereof.

### Extractable Fillers

Extractable fillers are used in the invention. Preferably, the fillers have average particle sizes in the range of 1 to 250 nanometers. Preferably, the fillers have average particle sizes in the range of 1 to 100 nanometers, and more preferably from 1 nm-50 nanometers. Particle size can be seen by scanning electron microscope. Examples of extractable filler include add or base extractable pore-formers which are typically hydrophobic such as silica, aluminum oxide, zirconium oxide, zinc oxide, iron oxide and calcium carbonate. Water extractable fillers are also possible by using such salts as water extractable compounds such as metallic salts (lithium, calcium and zinc salts). Preferred fillers include fine inorganic oxide powders (with average particle size 1-100 nm) including fumed silica, zinc oxide, aluminum oxide, zirconium oxide, iron oxide, and calcium carbonate.

### Other Additives

Before extraction of the solvent and fillers in the TIPS process, the composition may comprise additional additives. In addition to the fluoropolymer and solvent and extractable filler, one or more other additives may be added to the membrane composition, typically at from 0 to 10 weight percent, preferably at 1 to 10 weight percent and more preferably from 5 to 10 weight percent, based on the based on the weight percent of fluoropolymer. Typical additives include, but are not limited to, acrylic resin polymers, polymethylmethacrylate (PMMA), PMMA copolymers, poly-2-ethyioxazoiine, polyvinylacetate, polyethylene glycol, poiyyinyl alcohol, polyvinylpyrrolidone, poly-2-ethyloxazoline, polymethylvinylketone, polymethylmethacrylate-co-ethylacrylate, polymethylmethacrylate-co-butylacrylate, polymethymethacrylate-co-butylacrylate-co-hydroxyethylmethacrylate, polymethylmethacrylate-co-butylacrylate-co-methoxypolyethyeleneglycol-methacrylate, polymethylmethacrylate-co-methacrylic acid, polymethylmethacrylate-co-butylacrylate-co-methacrylic acid, polymethylmethacrylate-co-aminopropane sulfonic acid, polymethylmethacrylate-co-aminopropanesulfonic acid sodium salt, PMMA-zwitterion copolymers such as poly-methylmethacrylate-co-sulfobetaine methacrylate, polymethylmethacylate-co-phosphorylcholinemethacrylate, polymethymethacrylate-co-carboxybetaine methacrylate, polymethylmethacrylate-graft-vinylpyridine-sulfobetaine; and combinations thereof.

The composition formed by this inventive process can be formed into porous membranes by extrusion followed by thermally induced phase separation (TIPS).

Thermally Induced Phase Separation (TIPS) is one of two primary methods to make porous phase inversion membranes. TIPS is a form of polymer melt processing, in that a polymer material is melted with a diluent plasticizer or latent solvent to form a homogeneous melt. In the melt, the polymer and diluent are fully miscible. Upon cooling, the solubility of the polymer drops and it phase separates into a solid phase. When cast into an appropriate form factor (e.g. sheet, film, tube, hollow fiber) the thermal phase separation produces a porous structure.

Unlike the non-solvent induced phase separation process (NIPS) the latent solvents used in TIPS will not dissolve the polymer at room temperature. Heating close to the polymer melting point is needed to make a homogeneous solution. In the TIPS process, crystallization of the polymer as it cools is the driving process for phase separation, unlike non-solvent exchange in the NIPS process. Due to the crystallization process in TIPS, TIPS membranes have higher crystallinity than NIPS membranes and therefore higher strength.

TIPS membrane (thermal controlled- being significantly faster than NIPS process) have a uniform pore size throughout the structure whereas NIPS membrane being diffusion control produces a gradient in pore size through the membrane (asymmetric pore size distribution).

Furthermore, the use of a high temperature extrusion process allows much higher (as much as 2× or more) polymer solids in compared to a NIPS process. The higher polymer solids content also helps increase the mechanical strength of the TIPS membranes compared to NIPS membranes.

While high mechanical strength is an inherent property of TIPS membranes, they can suffer lower permeability compared to NIPS membranes. To improve permeability of TIPS membranes, extractable inorganic fillers are often used as part of the formulation and then extracted after the membranes are cast. By use of the inorganic fillers, TIPS membranes can achieve both higher strength and higher water permeability than typical NIPS membranes.

Therefore, desirable processes for making TIPS membranes should be able to utilize both higher polymer solids and extractable inorganic fillers to achieve the desired properties of high mechanical strength and high permeability.

The TIPS process is described above, and is the preferred process for forming a membrane using the powder blend of the invention. The powder pre-blend of the invention is free flowing at room temperature, allowing for the transfer of the powder pre-blend in the into the extruder and ultimately forming a membrane using a TIPS process.

The porous membranes can be in the form of flat sheets, supported sheets, tubes, or hollow fibers or supported hollow fibers.

The final dry thickness of the membranes of this invention are generally between 50 to 500 microns, and preferably from 100 to 300 microns. This can be measured using a cryofractured membrane in a scanning electron microscope, or an optical microscope using a calibrated eyepiece or sizing software.

### EXAMPLES

### Tensile Testing Method

Mechanical testing was done on an Instron 4201 universal test frame equipped with a fiber holder designed to wrap fibers around a spool. This prevented damage to the delicate hollow fibers by standard tensile bar grips. The gap spacing was 100 mm with a strain rate of 50 mm min⁻¹. Fibers were tested in the wet state. Replicates of five fibers were run and averaged.

### Water Permeability

To test pure water permeability, 5 loops of membrane approximately 30-40 cm long each were potted at one end into a ¾″ OD clear PVC tube of 50 cm length. The tube was filled with deionized water through the open end and then connected to a water permeation test manifold. Water permeability was measured in dead-end flow, outside-in through the fibers, at 0.5 bar pressure. The surface area of the membranes was determined by measuring fiber OD with an optical microscope, calculating the circumference, and the multiplying by the exposed length of fibers in the test module.

### Example 1

The final formulation to be produced in weight percent ingredients: 38% Kynar 761 (Melt viscosity of between 26 to 29 KPoise at 100 sec-1, at 230 C) fine powder/emulsion grade PVDF, 20% ZnO (Azo 66) and 42% dibutylsebacate (DBS).

The Kynar 761 and ZnO were added to a high speed Henschel mixer. These were preblended at 500 rpm for 2 minutes. Then the DBS (20% by weight of the combined dry powder) was gradually added through the port with the mixer running at 500 rpm over 5 minutes. The resultant powder was free flowing.

A 30 mm ZSK twin-screw extruder with a 36:1 L/D barrel was set up with a specific screw design to allow for the additional liquid DBS that was needed to be injected down stream with a loss-in-weight positive displacement liquid injection pump. The temperatures for the extruder were set to 190 C, the screw rpm at 200 rpm. The free-flowing powder was fed to the rear of the twin-screw at 10 lbs/hr while the DBS was fed down-stream at a rate of 3.8 lbs/hr to achieve the final formulation for this compound as noted above. The extrudate was strand pelletized using a cold water bath. The torque during compounding was measured at 22% and the melt temperature was 190 C, showing that there was no significant shear heating—even with a high viscosity PVDF such as Kynar 761 with a melt viscosity at 100 sec-1 and 235 C of 27 kpoise using ASTM D3835. The resultant pellets were analyzed for dispersion quality by extracting the DBS with Alcohol, then analysing by SEM for pore size and dispersion quality of the ZnO. In addition the ZnO was extracted with 2 molar sulfuric acid for 4 hrs.

The results show that fine powder produced using emulsion process can be uniformly fed to the extruder with addition of latent solvent added down stream to make the final formulation and can be pellitized.

### Example 2

Pellets prepared in example 1 were fed into a 1 inch single screw extruder with barrier screws and 24 to 1 L/D and 3 to 1 compression ratio. The extruder was run at 25 rpm with the tempreture profile shown in the following table.

| Conditions | |
|---|---|
| Barrel 1 ° F. | 300 |
| Barrel 2 ° F. | 350 |
| Barrel 3 ° F. | 370 |
| Clamp | 370 |
| Adapter | 360 |
| Die 1 ° F. {Top} | 360 |
| Die 2 ° F. {Bottom} | 360 |
| RPM | 25 |
| Roll Speed | 10 ft/min |
| Roll Temp ° F. | 60 |

Using the above equipment we produced 6″ wide film with thicknesses from 0.004 to 0.008 inch thick using an 8″ wide vertically mounted coat hanger die with a die gap of 0.01 inch. The films were cooled in a three roll stack with chrome polished rolls set at 60 F.

In the next step films will be soaked in alcohol and washed and then soaked in acid and washed to form a membrane.

A uniform pore structure is observed by SEM and or capillary flow porometry.

A uniform distribution of Zinc oxide is observed by SEM.

FIG. 1 shows the schematic procedure for preparation of the films for production of the membranes as described in examples 1 and 2.

### Example 3: (Comparative)

A 500 g slurry of PVDF resin in diethylphthalate was prepared with a fine powder PVDF with a series of resins with a D50 particle size as measured by Microtrac of 10 micron. The mixture contained 45% PVDF resin and 55% diethylphthalate. Diethylphthalate was first weighed out into a mixing jar, followed by addition of PVDF resin. The mixture was stirred up for 1 minute using a hand wisk to disperse the solids. The mixtures were allowed to sit for 2 hours to fully wet with solvent. The mixtures were then mixed again for 1 minute using a hand held electric powered wisk mixer. This more completely blended the resins into the solvent. The result was an intractable paste that could not be fed to a twin-screw extruder.

### Example 4: (Comparative)

### Casting of TIPS Membranes with Inorganic Filler Additive

A series of experiments were run using solvent and fine powder PVDF using the equipment described below.

The following example describes a batch process for casting TIPS membranes using a formulation made of fine powder PVDF resin, latent solvent, but without any inorganic filler additive.

In a 300 ml jacketed stainless steel mix vessel is blended PVDF fine powder resin and diethyly phthalate. The amounts used are listed in the table below. The mixture is heated to 200 C with stirring at 60-65 rpm by an internal overhead stirrer while under nitrogen. Dissolution of the resin is confirmed by withdrawing samples of the melt after 1.5 hrs, revealing a clear solution. Once dissolution is complete, the tank temperature is lowered to 170-180 C to be closer to the crystallization temperature. A tube in orifice spinneret is used to cast a hollow fiber from the melt. The molten solution of PVDF resin is pumped by a gear pump into the heated die (170-180 C) while ambient temperature diethylpthalate is pumped through the lumen of the fiber. The fiber is cast into an ambient temperature water bath through an air gap of 7 mm and collected on a reel with low tension. After collecting, the fiber is soaked in alcohol to remove the solvent and then water to remove the ethanol. No further post treatment was performed. Fibers were tested for water permeability by gluing into small plastic tubes and measuring water flux at bar with outside-in water flow. Mechanical testing was performed on an Instron test unit. Data for water permeability and mechanical strength are listed in the table.

These results show an inverse relationship between solids content and water permeability, while showing an increase in mechanical strength with increasing solids content. Thus, this method has limitations in the flux vs strength properties of these fibers.

| Concentration of PVDF | Water permeability | Tensile |
|---|---|---|
| resin (wt %) | Imbh | Strength MPa |
| 25 | 1200 | 2.27 |
| 30 | 625 | 2.78 |
| 32.5 | 385 | 4.32 |
| 35 | 184 | 5.47 |

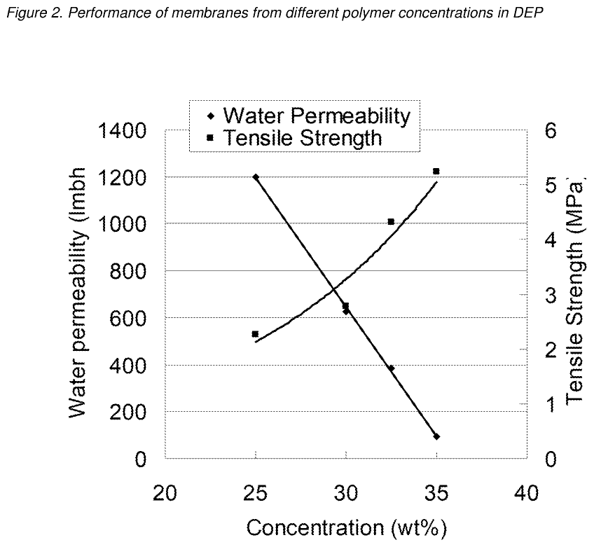

These experiments show the normal “trade-off” where without filler—if you get high strength—you get low permeability. See also FIG. 2.

### Example 5: (Comparative)

Blends were prepared by mixing powders and solvent blends in a blender. Different combinations of mixing sequences were tried. The goal was to make a free flowing powder. Visual inspection was done to see if powder was free flowing

Powder blend could be classified into three types:
Free flowing powder that easily poured out of blender
Chunky powder that could be poured out but in larger crumbly chunks, similar to cottage cheese

Paste that could not be poured out and had to be scooped out.

Formulation:

| | |
|---|---|
| Kynar 761 powder | 40 g |
| Dioctylphthalate/dibutylphthalate | 35 g (90% DOP, 10% DBP) |
| Zano20 (zinc oxide nano-powder) | 25 g |

This composition was used for all of these tests.

Test 1: Mix all together in blender

Mixed for 15 seconds twice. Blender strained by the end of the mix due to thickness of the mixture. Result was a paste that did not pour out of blender. It had to be scooped out.

Test 2: Premix Kynar powder and solvent, then add Zano 20

Mixed 40 g of Kynar and 15 g of solvent blend. Blended 2×15 seconds. Free flowing damp powder formed.

Added all 25 g of Zano to the 761/solvent blend and mixed 2×15 seconds. A free flowing damp powder resulted.

Add 10 g more of the solvent mix and blended 2×15 seconds. The powder clumped up and congealed into a paste. It could not be poured out of the blender. It had to be scooped out.

Test 3: Premix Zano 20 and solvent

Mixed all Zano with all of the solvent in the blender and mixed 2×15 seconds. A fluid slurry formed. Added Kynar 761 powder and blended again, 2×15 seconds. A thick paste formed that could not be poured out of the mill.

These results (Test 1—test 3) show that it is not possible to prepare a premix with fine powder PVDF such as Kynar 761

### Example 6: (Comparative)

Mixed Solef 6010 powder resin and Zano 20

Duplicating test 2 of Comparative example 5 with PVDF made by suspension with larger Particle size distribution (D50 of 115 micron), Solef 6010 powder (40 g) was blended with Zano (25 g) in blender, 2×15 second mix cycles. A free flowing powder mix resulted. Added solvent to this powder blend and then mixed again, 2×15 second cycles. The final blend could easily be poured out of the blender.

The results also show that with suspension grade larger particle size PVDF, the mixture is flowable. This shows that suspension grade PVDF does not behave in the same manner as emulsion grade PVDF.

1. A composition for TIPS membranes comprising
30 to 50% PVDF,
15 to 25% fine powder extractable filler having an average particle size of between 1 to 250 nm,
35 to 55% organic latent solvent, and
0 to 10% additives,
wherein the PVDF has a heat of melting Delta H of from 45 to 55 l/gm on the second heat D3418 (DSC), and the percent of reverse units by NMR is from 4.6 to 5.8.

2. The composition of claim 1 wherein the PVDF powder has a melting point of between 160 to 170 C on second heat.

3. The composition of claim 1 wherein the PVDF powder comprises from 30 to 45 wt percent of the composition and the organic latent solvent comprises from 35 to 42 wt percent of the composition.

4. The composition of claim 1 wherein the PVDF is a homopolymer or copolymer comprising at least 95 weight % vinylidene fluoride.

5. The composition of claim 1 wherein the fine powder extractable filler is selected from the group consisting of including fumed silica, zinc oxide, aluminum oxide, zirconium oxide, iron oxide, calcium carbonate, and combination thereof.

6. The composition of claim 1 wherein the latent solvent is selected from the group consisting of Diethyl phthalate, dibutylphthalate, dibutylsebacate, acetyl-tributylcitrate, tributylcitrate, acetyl-triethylcitrate and combinations thereof.

7. A method for producing a porous membrane comprising the steps of
(i) feeding the composition of claim 1, to an extruder,
(ii) extruding the melted product to form a structure,
(iii) Extracting the solvent from the structure with an organic solvent preferably alcohol,
(iv) Extracting the filler with acid or base, and
(v) washing the structure with pure water to produce a porous membrane.

8. A method for producing a porous membrane comprising the steps of
(a) pre-blending fine powder PVDF having a D50 of 3 to 15 micron, fine powder extractable filler having average particle sizes of between 1 to 250 nm and latent solvent to produce a free flowing powder blend, wherein the free flowing powder blend contains 15-30% by weight of a latent solvent,
(b) feeding the free flowing powder blend to an extruder or kneader wherein the free flowing powder blend is melted to produce a melted blend,
(c) feeding an additional aliquot of latent solvent down-stream in the extruder or kneader into the melted blend to produce a melted product,
(d) extruding the melted product to form a structure,
(e) extracting the solvent from the structure with organic solvent, preferably alcohol, and
(f) extracting the filler with acid or base, to produce a porous membrane.

9. The method of claim 8, wherein the PVDF has a heat of melting Delta H of from 45 to J/gm on the second heat ASTM D3418 (DSC), and the percent of reverse units by NMR is from 4.6 to 5.8.

10. The method of claim 8, further comprising step (g) of washing the structure with water after step (f).

11. The method of claim 8, wherein the amount of the additional aliquot of latent solvent is from 5 to 50 wt %, based on the total weight of the material prepared in (a).

12. The method of claim 8, wherein in step (a) the fine powder PVDF and the fine powder extractable filler are first blended together followed by the addition of the latent solvent.

13. The method of claim 8, further comprising the steps of
(c2) extrude out solid pellets from step (c), and
(c3) Feeding the pellets to a second extruder.

14. The method of claim 8, wherein the structure exiting step (d) extrudes into a water bath.

15. The method of claim 8, wherein the PVDF is a homopolymer or copolymer comprising at least 95 weight % vinylidene fluoride.

16. The method of claim 8, wherein the fine powder extractable filler is selected from the group consisting of including fumed silica, zinc oxide, aluminum oxide, zirconium oxide, iron oxide, and calcium carbonate and combination thereof.

17. The method of claim 7 or 8, wherein the fine powder extractable filler comprises fumed silica.

18. The method of claim 8, wherein the fine powder extractable filler comprises zinc oxide.

19. The method of claim 8, wherein the latent solvent is selected from the group consisting of dimethyl phthalate, diethylphthalate, dibutylphthalate, dioctylphthalate, diethylhexylphthalate, dibutylsebacate, triethylcitrate, acetyl-triethylcitrate, tributylcitrate, acetyl-tributylcitrate, glycerol triacetate (Triacetin), glycerol tributyrate (Tributyrin), propylene carbonate, diphenylearbonate, butyllevulinate, n-octylpyrrolidone, benzoic acid esters such as methyl benzoate and ethyl benzoate, phosphoric acid esters such as triphenyl phosphate, tributyl-phosphate, and tricresyl phosphate dimethyl succinate, diethyl succinate, gamma valerolactone, and mixtures thereof.

20. The method of claim 8, wherein the latent solvent is selected from the group consisting of Diethyl phthalate, dibutylphthalate, dibutylsebacate, acetyl-tributylcitrate, tributylcitrate, acetyl-triethylcitrate, triethylcitrate, and combinations thereof.

21. (canceled)

22. A membrane made by the method of claim 8, wherein the membrane has a flowrate of at least 800 lmhb and a tensile strength of at least 8 MPa.
